(19) United States
(12) Patent Application Publication
(10) Pub. No.: US 2025/0341752 A1
(43) Pub. Date: Nov. 6, 2025

(54) Optical Circuit Switch and Beam Processing Method

(71) Applicant: II-VI Delaware, Inc., Wilmington, DE (US)

(72) Inventors: Haijun Yuan, Dublin, CA (US); Jack R. Kelly, Lake Mary, FL (US); Haiji J. Yuan, Cupertino, CA (US); Yajun Wang, Naperville, IL (US); Qingyu Li, Cupertino, CA (US)

(21) Appl. No.: 18/654,597

(22) Filed: May 3, 2024

(51) Int. Cl. G02F 1/313; G02F 1/13363

(52) U.S. Cl. CPC G02F 1/313; G02F 1/133638; G02F 2203/07

(57) ABSTRACT

An optical switching apparatus for optical switching of input beams from a plurality of optical fibers includes a plurality of digital switching blocks arranged in series or as a multi-dimensional array. The digital switching blocks include a plurality of liquid crystal (LC) cells arranged in series configured to control polarization of the input beams, and a plurality of birefringent wedges that direct the input beams based on polarization. The one or more of the plurality of birefringent wedges is disposed between adjacent LC cells of the plurality of LC cells. The digital switching blocks include 1×2^{N} digital switching blocks, with N being an integer value equal to a number of the plurality of LC cells or a number of the plurality of birefringent wedges for one of the switching blocks.

### BACKGROUND

### Field

The present disclosure is directed to components of optical connection systems and, in particular, to devices, assemblies, and systems comprising optical circuit switches that process optical signals providing optical connectivity for various computing and communications devices and systems.

### Description of Related Art

Optical systems use optical signals traveling through optical channels, such as optical fibers or waveguides, to transmit data. The optical systems can comprise switching devices for selective switching of optical signals passing through the systems. However, as data rates of the optical signals increase, the frequency response of the optical signals may be altered.

One way to overcome or reduce frequency loss due to changes in frequency response is to switch optical signals directly rather than converting the signal to an intermediate electrical signal. A number of optical switches are available for such direct optical switching, which eliminate the need to convert the optical signal to an interim electrical signal. These optical switches incorporate various optical switch elements, such as tunable mirrors, prisms, fiber collimators, and drive mechanisms, to route optical signals through the switch.

Some optical switches are based on a micro-electromechanical (MEM) devices, in which components of the optical switch are manipulated by MEMs devices to route the optical signal through the switch. In one particular example, an optical switch comprising micro-electromechanical (MEM) mirrors can be used for connecting optical fibers in a first set of optical fibers to optical fibers in a second set of optical fibers. Optical switches with liquid crystals (LC) with limited port numbers are also known. These technologies use free space optics, in which the optical signal is removed from the optical fiber or waveguide, manipulated using unguided optical components, and then reinserted into an output optical fiber or waveguide.

However, there is a need in the art for improved optical switch designs. In particular, there is a need for optical switches with improved reliability and which are less prone to temperature and aging related drift, meaning that auxiliary active alignment may not be required. There is also a need for low power optical switching devices, which do not require active moving of mechanical parts. The optical switches disclosed herein are configured to address these issues.

### SUMMARY

According to an aspect of the disclosure, an optical switching apparatus for optical switching of input beams from a plurality of optical fibers includes a plurality of digital switching blocks arranged in series or as a multi-dimensional array. The digital switching blocks include a plurality of liquid crystal (LC) cells arranged in series configured to control polarization of the input beams, and a plurality of birefringent wedges that direct the input beams based on polarization. The one or more of the plurality of birefringent wedges is disposed between adjacent LC cells of the plurality of LC cells. The digital switching blocks include 1×2N digital switching blocks, with N being an integer value equal to a number of the plurality of LC cells or a number of the plurality of birefringent wedges for one of the switching blocks. The input beams are subject to optical switching by the plurality of LC cells and the plurality of wedges of the plurality of digital switching blocks to produce output beams.

According to another aspect of the disclosure, a method for processing input beams from a plurality of input optical fibers includes: transmitting the input beams from the plurality of input optical fibers to an optical switching apparatus; providing linear polarization for the input beams; and selectively directing the input beams to a plurality of switching blocks of the optical circuit switching apparatus to provide switched output beams. The switching blocks include a plurality of liquid crystal (LC) cells configured to control polarization of the input beams arranged in series, and a plurality of birefringent wedges that direct the input beams based on polarization, wherein at least one of the plurality of birefringent wedges is disposed between adjacent LC cells of the plurality of LC cells. The digital switching blocks include 1×2N digital switching blocks, with N being an integer value equal to a number of the plurality of LC cells and/or a number of the plurality of birefringent wedges for one of the switching blocks. The method also includes, after the input beams pass through the switching blocks to produce the switched output beams, directing the switched output beams to a plurality of output optical fibers.

According to another aspect of the disclosure, an optical switching assembly includes a plurality of input optical fibers; a plurality of output optical fibers; an input fiber array having a first plurality of digital switching blocks configured to receive input beams from the plurality of input optical fibers; and an output fiber array including a second plurality of the digital switching blocks configured to produce output beams from switched beams received from the input fiber array. The digital switching blocks of the first and second pluralities of digital switching blocks include: a plurality of liquid crystal (LC) cells configured to control polarization of an input beam arranged in series, and a plurality of birefringent wedges that direct the input beam based on polarization. One or more of the plurality of birefringent wedges is disposed between adjacent LC cells of the plurality of LC cells. The digital switching blocks include 1×2N digital switching blocks, with N being an integer value equal to a number of the plurality of LC cells or a number of the plurality of birefringent wedges for one of the switching blocks.

According to another aspect of the disclosure, a computing device or data center includes one or more of the previously described optical switching assemblies.

According to another aspect of the disclosure, a Liquid Crystal on Silicon (LCoS) optical switch, includes: an input LCOS device configured to receive input beams from a plurality of input optical fibers and to selectively direct first-order diffracted beams to selected locations or pixels based on polarization; and an output LCOS device configured to receive the first-order diffracted beams from the input LCOS device and to selectively direct the beams to a plurality of output optical fibers based on polarization of the diffracted beams.

Non-limiting examples of the present disclosure will now be described in the following numbered clauses:

Clause 1: An optical switching apparatus for optical switching of input beams from a plurality of optical fibers, the optical switching apparatus comprising: a plurality of digital switching blocks arranged in series or as a multi-dimensional array, the plurality of digital switching blocks comprising: a plurality of liquid crystal (LC) cells arranged in series configured to control polarization of the input beams, and a plurality of birefringent wedges that direct the input beams based on polarization, wherein one or more of the plurality of birefringent wedges is disposed between adjacent LC cells of the plurality of LC cells, wherein the plurality of digital switching blocks comprise 1×2N digital switching blocks, with N being an integer value equal to a number of the plurality of LC cells or a number of the plurality of birefringent wedges for one of the plurality of digital switching blocks, and wherein the input beams are subject to optical switching by the plurality of LC cells and the plurality of birefringent wedges of the plurality of digital switching blocks to produce output beams.

Clause 2: The optical switching apparatus of clause 1, wherein the optical switching apparatus comprises M input ports configured to receive the input beams from the plurality of optical fibers and N′ output ports configured to receive switched beams from the plurality of digital switching blocks, wherein M and N′ are integer values greater than or equal to 1.

Clause 3: The optical switching apparatus of clause 2, wherein the number (N) of the plurality of LC cells or a number of the plurality of birefringent wedges for one of the switching blocks is less than the number (N′) of output ports (e.g., N<N′).

Clause 4: The optical switching apparatus of clause 2 or clause 3, wherein the optical switching apparatus is configured to provide an M×N′ optical circuit switch with full switching functionality.

Clause 5: The optical switching apparatus of any of clauses 2-4, wherein the optical switching apparatus comprise a rectangular array in which M<N′.

Clause 6: The optical switching apparatus of any of clauses 2-5, wherein the optical switching apparatus provides a square array, with M=N′.

Clause 7: The optical switching apparatus of any of clauses 2-6, wherein M and N′ are equal to 32, and the optical switching apparatus is configured to provide full switching functionalities for at least 32×32 ports of the optical switching apparatus.

Clause 8: The optical switching apparatus of any of clauses 2-7, wherein M and N′ are equal to 512, and the optical switching apparatus is configured to provide full switching functionalities for at least 512×512 ports of the optical switching apparatus.

Clause 9: The optical switching apparatus of any of clauses 2-8, wherein M and N′ are integer values from 32 to 512.

Clause 10: The optical switching apparatus of any of clauses 1-9, further comprising the plurality of optical fibers configured to deliver the input beams to the optical switching apparatus.

Clause 11: The optical switching apparatus of clause 10, further comprising at least one collimator array and, optionally lenses (e.g., an optical power devices), configured to align the input beams to the plurality of digital switching blocks.

Clause 12: The optical switching apparatus of any of clauses 1-11, further comprising polarization diversity control optics (e.g., a transflective polarizing element configured to transmit a linear polarization state) configured to convert the input beams to input beams with linear polarization.

Clause 13: The optical switching apparatus of clause 12, wherein the polarization diversity control optics comprises a beam splitter (e.g., a beam dispersion device) configured to separate the input beams into multiple beams and at least one waveplate configured to rotate some of the multiple beams (e.g., by about 90 degrees) to provide the linear polarization for the input beams.

Clause 14: The optical switching apparatus of any of clauses 1-13, further comprising output polarization diversity optics (a transflective polarizing element configured to change a linear polarization state) for changing polarization of the output beams from linear polarization to an orthogonal linear state of polarization.

Clause 15: The optical switching apparatus of clause 14, wherein the output polarization diversity optics comprise at least one waveplate for rotating some of the output beams by 90 degrees so that the output beams are in that orthogonal linear state of polarization and at least one beam splitter (e.g., a beam dispersion device or displacer) for combining the output beams.

Clause 16: The optical switching apparatus of clause 14 or clause 15, further comprising at least one collimator array, and optionally at least one lens, for directing output beams from the plurality of switching blocks to a plurality of output fibers.

Clause 17: The optical switching apparatus of any of clauses 1-16, further comprising output optical fibers configured to receive the output beams from the plurality of switching blocks of the optical switching apparatus.

Clause 18: The optical switching apparatus of any of clauses 1-17, further comprising an optical alignment adjustment device configured to account for component tolerance in the input and/or output beam.

Clause 19: The optical switching apparatus of clause 18, wherein the optical alignment adjustment device comprises a TFT-LCD device.

Clause 20: The optical switching apparatus of any of clauses 1-19, further comprising an LCOS switch device.

Clause 21: The optical switching apparatus of any of clauses 1-20, further comprising a TFT-LCD switch device.

Clause 22: The optical switching apparatus of any of clauses 1-21, wherein the plurality of digital switching blocks are arranged as a one-dimensional or multidimensional input array configured to receive the input beams and a one-dimensional or multidimensional output array configured to receive the input beams from the input array and to provide output beams to a plurality of output optical fibers.

Clause 23: The optical switching apparatus of clause 22, wherein the input array and/or the output array comprise switching blocks of the plurality of digital switching blocks that are arranged in series in a single row of at least 16 blocks.

Clause 24: The optical switching apparatus of clause 23, wherein the input array and/or the output array comprise switching blocks of the plurality of digital switching blocks are arranged as a multi-dimensional array.

Clause 25: The optical switching apparatus of clause 24, wherein the multi-dimensional array is a square with sides comprising an equal number of the plurality of blocks.

Clause 26: The optical switching apparatus of clause 24 or clause 25, wherein the multi-dimensional array is rectangular having a height and width comprising different numbers of the plurality of switching blocks.

Clause 27: A method for processing input beams from a plurality of input optical fibers, the method comprising: transmitting the input beams from the plurality of input optical fibers to an optical switching apparatus; providing linear polarization for the input beams; selectively directing the input beams to a plurality of digital switching blocks of the optical circuit switching apparatus to provide switched output beams, wherein the plurality of digital switching blocks comprise a plurality of liquid crystal (LC) cells configured to control polarization of the input beams arranged in series, and a plurality of birefringent wedges that direct the input beams based on polarization, wherein at least one of the plurality of birefringent wedges is disposed between adjacent LC cells of the plurality of LC cells, wherein the plurality of digital switching blocks comprise 1×2N digital switching blocks, with N being an integer value equal to a number of the plurality of LC cells and/or a number of the plurality of birefringent wedges for one of the plurality of digital switching blocks; after the input beams pass through the switching blocks to produce the switched output beams, directing the switched output beams to a plurality of output optical fibers.

Clause 28: The method of clause 27, wherein the optical switching apparatus comprises M input ports configured to receive the input beams and N′ output ports configured to receive the switched output beams from the plurality of digital switching blocks, wherein M and N′ are integer values greater than or equal to 1.

Clause 29: The method of clause 27 or clause 28, wherein transmitting the input beams to the optical switching apparatus comprises passing the input beams through the plurality of input optical fibers.

Clause 30: The method of clause 29, wherein transmitting the input beams to the optical switching apparatus further comprises passing the input beams through a collimator array configured to align the input beams to the optical switching apparatus.

Clause 31: The method of any of clauses 27-30, further comprising passing the input beams through polarization diversity control optics (e.g., a transflective polarizing element) configured to provide linear polarization for the input beams.

Clause 32: The method of clause 31, wherein the polarization diversity control optics comprise a beam splitter (e.g., a beam dispersion device) configured to separate the input beams into multiple beams and at least one waveplate configured to rotate some of the multiple beams (e.g., by about 90 degrees) to provide the linear polarization.

Clause 33: The method of any of clauses 27-32, further comprising passing the switched output beams through output polarization diversity control optics configured to rotate some of the output beams by 90 degrees so that the beams are in an orthogonal linear state of polarization and spatially combining the switched output beams.

Clause 34: The method of clause 33, wherein the output polarization diversity optics comprise at least one waveplate for rotating some of the output beams by 90 degrees so that the beams are in the orthogonal linear state of polarization and at least one beam splitter (e.g., a beam dispersion device) for combining the output beams.

Clause 35: The method of any of clauses 27-34, wherein directing the switched output beams to the plurality of optical fibers comprises passing the switched output beams through a collimator array, and optionally lenses (e.g., an optical power devices), to guide the output beams to the plurality of output optical fibers.

Clause 36: The method of any of clauses 27-35, further comprising activating an optical alignment adjustment device to account for component tolerance in the input and/or output beam.

Clause 37: An optical switching assembly, comprising a plurality of input optical fibers; a plurality of output optical fibers; an input fiber array comprising a first plurality of digital switching blocks configured to receive input beams from the plurality of input optical fibers; and an output fiber array comprising a second plurality of the digital switching blocks configured to produce output beams from switched beams received from the input fiber array, wherein digital switching blocks of the first and second pluralities of digital switching blocks comprise: a plurality of liquid crystal (LC) cells configured to control polarization of an input beam arranged in series, and a plurality of birefringent wedges that direct the input beam based on polarization, wherein one or more of the plurality of birefringent wedges is disposed between adjacent LC cells of the plurality of LC cells, and wherein the digital switching blocks comprise 1×2N digital switching blocks, with N being an integer value equal to a number of the plurality of LC cells or a number of the plurality of birefringent wedges for one of the digital switching blocks.

Clause 38: The optical switching assembly of clause 37, wherein the input fiber array is configured to receive input beams from M input ports and the output fiber array is configured to provide output beams to N′ output ports in order to provide full switching functionality for Mx N′ optical circuits, wherein M and N′ are integer values greater than or equal to 1.

Clause 39: The optical switching assembly of clause 38, wherein the number (N) of the plurality of LC cells or a number of the plurality of birefringent wedges for one of the switching blocks is less than the number (N′) of output ports (e.g., N<N′).

Clause 40: The optical switching assembly of clause 38 or clause 39, wherein M and N′ are integer values from 32 to 512.

Clause 41: The optical switching assembly of any of clauses 37-40, further comprising a collimator array, and optionally lenses (e.g., an optical power devices), configured to align the input beams with the first plurality of digital switching blocks of the input fiber array.

Clause 42: The optical switching assembly of any of clauses 37-41, further comprising at least one output collimator array, and optionally lenses (e.g., an optical power devices), configured to spatially combine the output beams.

Clause 43: The optical switching assembly of any of clauses 37-42, further comprising output polarization diversity optics (a transflective polarizing element configured to change a linear polarization state) for changing polarization of the output beams from linear polarization to an orthogonal linear state of polarization.

Clause 44: The optical switching assembly of clause 43, wherein the output polarization diversity optics comprise at least one waveplate for rotating some of the output beams by 90 degrees so that the beams are in the orthogonal linear state of polarization and at least one beam splitter (e.g., a beam dispersion device or beam displacer) for combining the output beams.

Clause 45: The optical switching assembly of any of clauses 37-44, further comprising a collimator array, and optionally lenses (e.g., an optical power devices), configured to align the input beams to the first plurality of switching blocks of the input fiber array.

Clause 46: The optical switching assembly of any of clauses 37-45, further comprising a collimator array, and optionally lenses (e.g., optical power devices) for guiding output beams from the second plurality of switching blocks of the output fiber array to fibers of the output optical fibers.

Clause 47: The optical switching assembly of any of clauses 37-46, wherein the first plurality of digital switching blocks of the input fiber array is arranged as a one-dimensional or multidimensional input array configured to receive the input beams.

Clause 48: The optical switching assembly of any of clauses 37-47, wherein the second plurality of digital switching blocks of the output fiber array is arranged as a one-dimensional or multidimensional output array configured to provide the output beams to the output optical fibers.

Clause 49: The optical switching assembly of any of clauses 37-48, wherein the input fiber array and/or the output fiber array comprise switching blocks of the first and/or second plurality of digital switching blocks that are arranged in series in a single row of at least 16 blocks.

Clause 50: The optical switching assembly of any of clauses 37-49, wherein the input fiber array and/or the output fiber array comprise switching blocks of the first and/or second plurality of digital switching block arranged as a multi-dimensional array.

Clause 51: The optical switching assembly of clause 50, wherein the multi-dimensional array is a square with sides comprising an equal number of switching blocks.

Clause 52: The optical switching assembly of clause 50 or clause 51, wherein the multi-dimensional array is rectangular having a height and width comprising different numbers of switching blocks.

Clause 54: A computing device or data center comprising one or more of the optical switching assemblies of any of clauses 37-52.

Clause 55: A Liquid Crystal on Silicon (LCoS) optical switch, comprising: an input LCoS device configured to receive input beams from a plurality of input optical fibers and to selectively direct first-order diffracted beams to selected locations or pixels based on polarization; and an output LCOS device configured to receive the first-order diffracted beams from the input LCOS device and to selectively direct the beams to a plurality of output optical fibers based on polarization of the diffracted beams.

Clause 56: The optical switch of clause 55, wherein the input LCOS device and/or the output LCoS device comprise a phase grating profile with addressable pixels, which are liquid crystal based.

Clause 57: The optical switch of clause 55 or clause 56, further comprising an input collimator array configured to direct the input beams from the plurality of input optical fibers to the input LCOS device.

Clause 58: The optical switch of any of clauses 55-57, further comprising an output collimator configured to direct the output beams from the output LCOS device to the plurality of output optical fibers.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

FIG. 1 is a schematic drawing of an optical switch comprising mirrors positioned by MEMs, as are known in the prior art;

FIG. 2 is a schematic drawing of an optical switch, according to an aspect of the present disclosure;

FIG. 3A is a schematic drawing of a digital switching block of an optical switch, according to an aspect of the present disclosure;

FIG. 3B is another schematic drawing of a digital switching block showing two-dimensional switching of a single fiber, according to an aspect of the present disclosure;

FIG. 3C is another schematic drawing of a digital switching block showing switching of a single fiber to one of four states, according to an aspect of the present disclosure;

FIG. 3D is a schematic drawing of an optical switch showing switching between four input optical fibers and four output optical fibers, according to an aspect of the present disclosure;

FIG. 3E is a schematic drawing of the optical switch of FIG. 3D showing switching of the four input optical fibers to four different output optical fibers;

FIG. 3F is a schematic drawing of another example of an optical switch including a horizontal digital switching block and a vertical digital switching block, according to an aspect of the present disclosure;

FIG. 4 is a schematic drawing of a computing device including an optical switch, according to an aspect of the present disclosure;

FIG. 5A is a schematic drawing of another example of an optical switch including one-dimensional switching blocks, according to an aspect of the present disclosure;

FIG. 5B schematic drawing of another example of an optical switch including one dimensional switching blocks, according to an aspect of the present disclosure;

FIG. 6A is a schematic drawing of another example of an optical switch including multi-dimensional switching blocks, according to an aspect of the present disclosure;

FIG. 6B is a schematic drawing of another example of an optical switch including multi-dimensional switching blocks, according to an aspect of the present disclosure;

FIG. 6C is a schematic drawing of another example of an optical switch including multi-dimensional switching blocks, according to an aspect of the present disclosure;

FIG. 7 is a flow chart showing a method for processing input beams with an optical switch to produce output beams, according to an aspect of the present disclosure; and

FIG. 8 is a schematic drawing of an optical switch including LCOS devices for switching an optical signal, according to an aspect of the present disclosure.

### DETAILED DESCRIPTION

As used herein, the singular form of “a”, “an”, and “the” include plural referents unless the context clearly dictates otherwise. For the purposes of this specification, unless otherwise indicated, all numbers expressing quantities of ingredients, reaction conditions, dimensions, physical characteristics, and so forth used in the specification and claims are to be understood as being modified in all instances by the term “about.”

As used herein, the terms “right”, “left”, “top”, and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings, and described in the following specification, are examples. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

The present disclosure is directed to optical circuit switches 110, 210, 310, 510, switching apparatus, and switching assemblies, as well as to techniques for processing an input signal, such as an input signal with multiple input beams, by passing the signal through one or more optical circuit switches. In general, optical switches, such as the optical switches 110, 210, 310, 510, are configured to switch or redirect input beams or components of optical signals from input optical fibers to one or multiple output optical fibers. In some examples, the connections can be bidirectional. Desirably, the optical circuit switches 110, 210, 310, 510 are configured to provide stable and reliable optical connections for transmission of optical signals between input optical fibers and output optical fibers, and without using mechanical parts. Furthermore, the switching is not wavelength dependent.

In some examples, optical circuit switches 110, 210, 310 disclosed herein can comprise liquid crystal (LC) circuit switches. The present inventors believe that such LC circuit switches can be highly reliable compared to MEMs or piezoelectric devices, because the LC circuit switches do not have any mechanical moving parts. Further, such LC circuit switch designs can be very stable, such that auxiliary active alignment may not be needed. For these reasons, it is believed that optical connections, such as the LC circuit switches of the present disclosure, can provide benefits including low power consumption and low cost compared to existing optical switches using mechanical components. In particular, it is believed that optical connections comprising the LC circuit switches of the present disclosure can be used for tensor processing units (TPUs) and/or graphical processing units (GPUs) in a data center and/or for supercomputer machine learning and artificial intelligence (ML/AI) applications. Also, because switching occurs directly (i.e., without converting an input signal to another type of signal, such as an electrical signal) and without mechanical or moving parts, the optical switches 110, 210, 310, provide fiber-to-fiber switching that is not dependent upon or limited to particular data rates.

In some examples, the liquid crystal optical circuit switches 110, 210, 310 of the present disclosure are configured to provide M×N optical circuit switching functionality. As described in further detail herein, an M×N optical switch has M input ports and N output ports. The M×N optical switch can be configured to selectively provide a signal received at one of the M input ports to any of the N output ports. The optical switches 110, 210, 310 can comprise multiple switching blocks 112, 312 arranged together to provide the M×N switching capability. For example, the switching blocks 112, 312 can be 1×2^{N} basic switching blocks 112, 312 arranged to form one-dimension or multi-dimension arrays for receiving and processing input signals. Examples of switching blocks, which can be adapted for use with the optical switching apparatus are described, for example, in U.S. Pat. No. 7,492,986, entitled “Apparatus and method for optical switching with liquid crystals and birefringent wedges”, which is incorporated herein by reference in its entirety. Other LC switching block arrangements can also be used for the optical circuit switches 110, 310, within the scope of the present disclosure.

### Optical Circuit Switch Including MEMs Devices

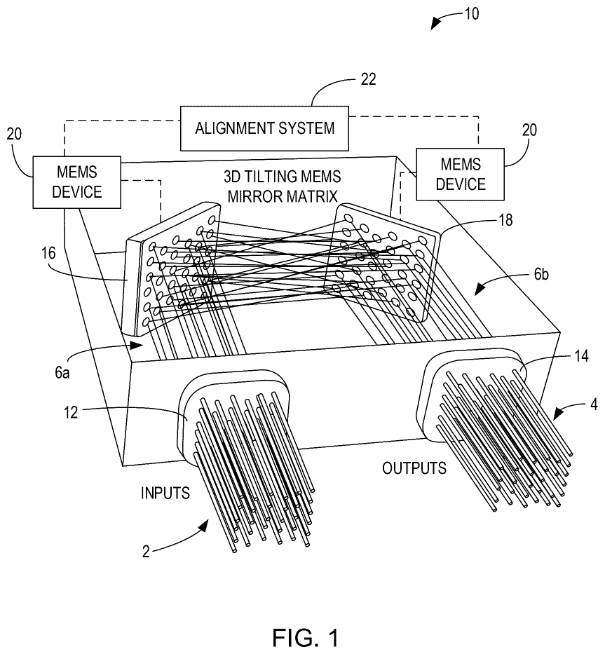

As previously described, the optical circuit switches 110, 210, 310 are configured to be an alternative to optical circuit switches with mechanical parts, such as MEMs or piezoelectric engines. An example of an optical circuit switch 10 that includes mirror(s) manipulated by MEMs is shown in FIG. 1. Unfortunately, piezoelectric and MEMs technologies are mechanical in nature and have mechanical moving parts, which can be prone to failure and/or inaccuracy. Furthermore, high voltages are required to tilt mirrors using MEMs devices. As such, reliability for such electromechanical optical circuit switch 10 can be an issue. In addition, active alignment adjustment with a feedback loop may be needed to compensate for drifting in such optical circuit switches 10.

As shown in FIG. 1, the MEMs optical circuit switch 10 comprises two-dimensional fiber or collimator arrays, namely an input collimator array 12 and an output collimator array 14. The input collimator array 12 can be configured to receive input beams 2 and to direct the input beams 2 through the optical circuit switch 10. The input collimator array 12 may also provide spacing between the input beams 2 and/or make the input beams 2 parallel producing beams 6a configured to pass into the optical circuit switch 10. In a similar manner, the output collimator array 14 can be configured to make beams 6b from the optical circuit switch 10 parallel and/or to provide spacing between the beams 6b from the optical circuit switch 10, producing output beams 4. The output collimator array 14 can also be configured to direct the output beams 4 from the optical circuit switch 10 to, for example, output optical fibers (not shown in FIG. 1) for directing output optical signals to other locations or devices. The input collimator array 12 and the output collimator array 14 can be identical in size, shape, and orientation, as shown in FIG. 1. In other examples, the collimator arrays 12, 14 can be different sizes or shapes. For example, the input collimator array 12 can be an M×M array, while the output collimator array 14 can be an M×N array or an N×N array.

In some examples, the optical circuit switch 10 can also comprise one or more lens (e.g., two-dimensional lens (not shown)) for directing the input beams 2 from the input collimator array 12 to the optical circuit switch 10 and/or for directing output beams 4 from the optical circuit switch 10. For example, lens can be positioned within individual collimators of the arrays 12, 14.

As shown in FIG. 1, the optical circuit switch 10 further comprises the mirrors 16, 18 controlled by MEMS or piezoelectric devices 20 configured to direct the beams 6a to designated or selected output locations producing the beams 6b. For example, the optical circuit switch 10 can comprise a first mirror 16 configured to reflect the beams 6a received from the input collimator array 12 towards a second mirror 18. The second mirror 18 can be configured to provide reflected beams 6b, which are directed to the output collimator array 14. In some examples, the mirrors 16, 18 can be three-dimensional (3D) tilting MEMs mirror matrixes. In some instances, the mirrors 16, 18 can be controlled by the MEMS or piezoelectric device 20 to steer light beams from input fibers to designated output fibers.

In some examples, the MEMS mirrors 16, 18 shown in FIG. 1 can be lithographically-produced mirrors that are operated with voltage signals applied through integrated circuits produced with similar lithographic techniques. These mirrors 16, 18 typically are very small having dimensions measured in millimeters or fractions of millimeters. The mirrors 16, 18 are designed with extremely tight tolerances necessary for proper angular alignment of the various reflective elements, and usually require a very sophisticated feedback control system. For example, the mirrors 16, 18 can be configured to be deformed or reoriented using electrostatic forces provided by the MEMs or piezoelectric devices 20. Because the MEMs or piezoelectric devices 20 rely on steering a reflected beam to a desired location or position, controlling the angle of reflection is paramount. As such, small deviations (<0.1 degree) in signal deflection can dramatically increase the coupling losses to an output port. For these reasons, fabrication of the MEMs arrays requires an expensive processing facility, which makes them a costly solution for low volume applications. As previously described, the optical circuit switches 110, 210, 310 disclosed herein are configured to provide optical switching capabilities without the difficulties of these MEMs or piezoelectric devices 20, as shown in FIG. 1.

The optical circuit switch 10 of FIG. 1 may also include an auxiliary active alignment adjustment system 22. The auxiliary active alignment adjustment system 22 can be configured to provide a feedback loop in order to identify and compensate for alignment drifting caused by positioning of the MEMs mirrors 16, 18. For example, the auxiliary active alignment adjustment system 22 can comprise camera unit(s) for viewing positioning of alignment beams from MEMs mirrors 16, 18 and processors or other electronic circuitry configured to adjust a position of the mirrors when improper alignment is detected. An example of an alignment unit, which can be used with the optical circuit switch 10 and/or which can be adapted for use with other optical circuit switches 110, 310 of the present disclosure, is shown in U.S. Pat. No. 7,548,682, entitled “Optical Fiber Array Alignment Unit,” which is incorporated herein by reference.

### Liquid Crystal (LC) Optical Switch

In contrast to the optical circuit switch 10 comprising the MEMs mirrors 16, 18 shown in FIG. 1, the present disclosure is directed to the optical circuit switches 110, 210, 310 comprising liquid crystal (LC) optical circuit switching portions 114, 214, 314. As previously described, the LC optical circuit switching portions 114, 214, 314 disclosed herein can be configured to provide M×N optical circuit switching functionality without mechanical moving parts. The optical circuit switches 110, 210, 310 can comprise one or more 1×2^{N} basic switching blocks 112, 212, 312 arranged to provide the M×N switching functionality. For example, the LC optical circuit switching portions 114, 214, 314 can comprise multiple 1×2^{N} basic switching blocks 112, 212, 312 configured to form the M×N optical circuit switch, in which insertion loss of the device is kept low. The switching blocks 112, 212, 312 can be arranged in a one-dimensional or two-dimensional arrangement.

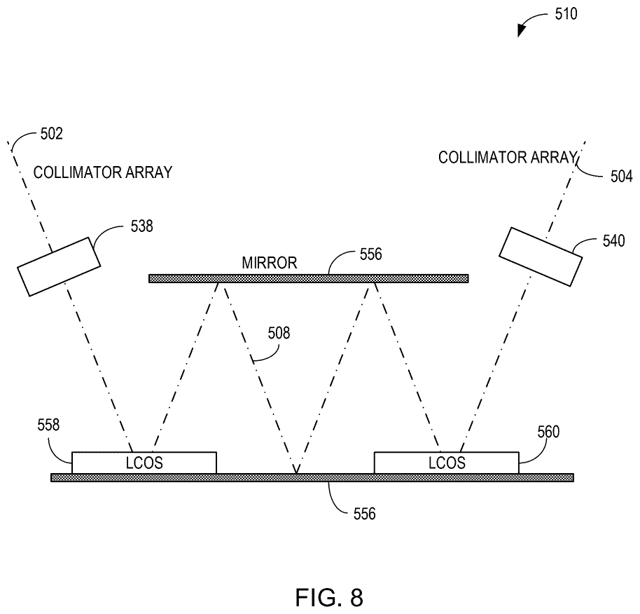

In some examples, the LC optical circuit switching portions 114, 214, 314 disclosed herein can be configured to function as a digital LC switch. Similar switch configurations have also been used in Wavelength Selective Switching (WSS) applications. Furthermore, in some examples, a thin-film-transistor liquid-crystal display (TFT-LCD) or a similar type of LC cell may be inserted into the optical path of the optical switch apparatus to provide alignment and/or fine adjustment. In addition, polarization diversity control optics can be used to convert the optical signal to linear polarization. In some examples, as described in further detail herein, a liquid crystal on silicon (LCoS) arrangement can also be used to achieve similar functionalities, as shown in FIG. 8.

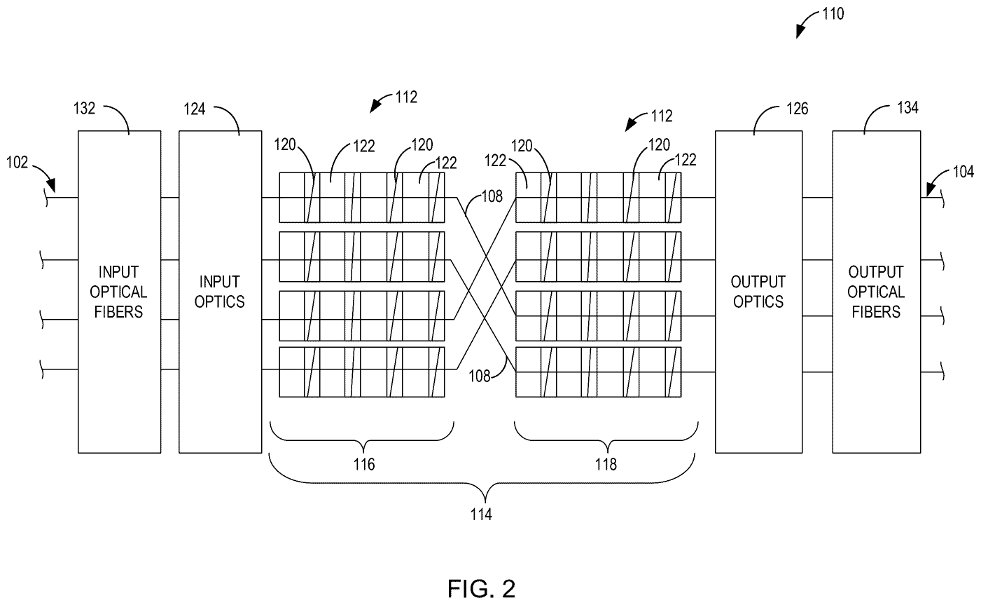

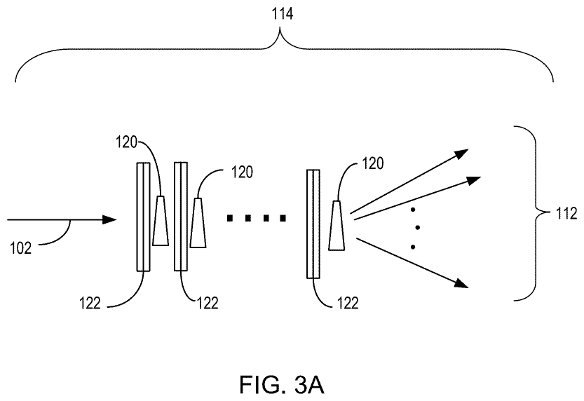

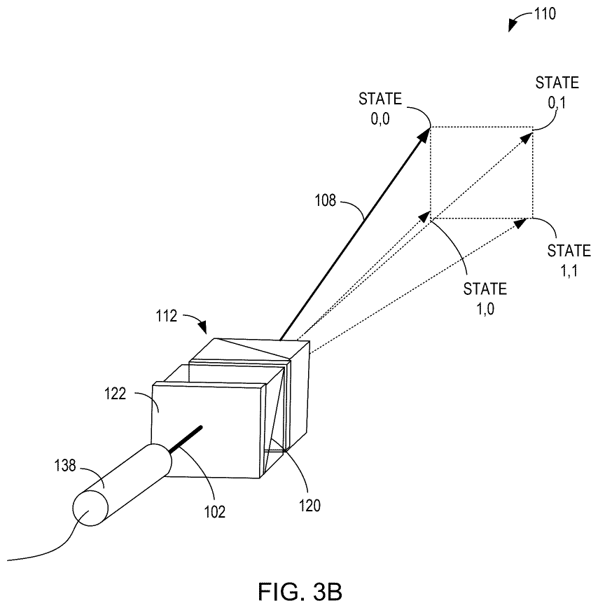

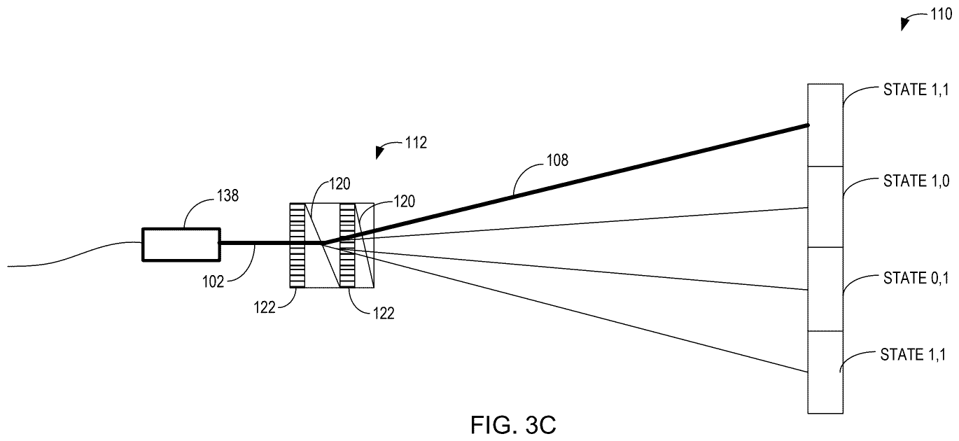

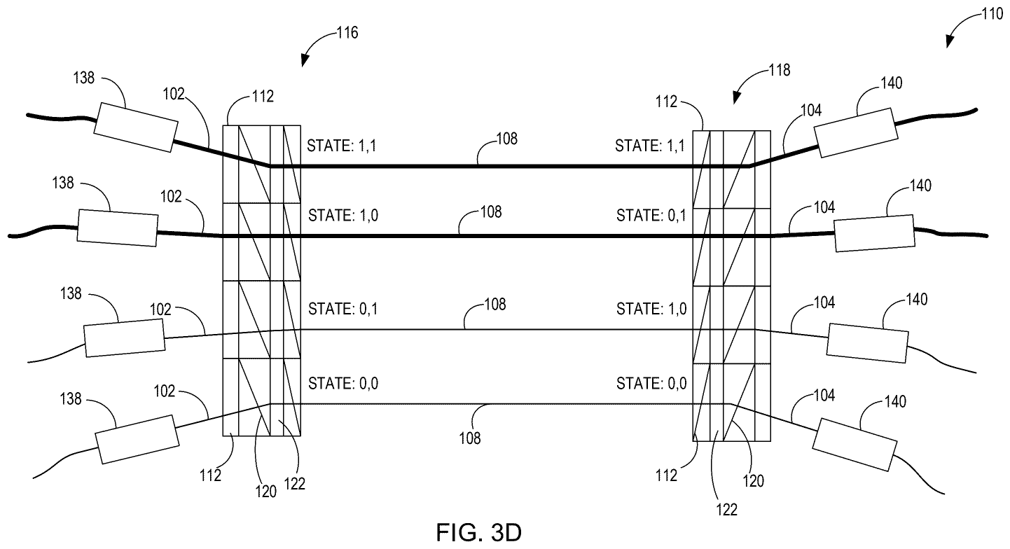

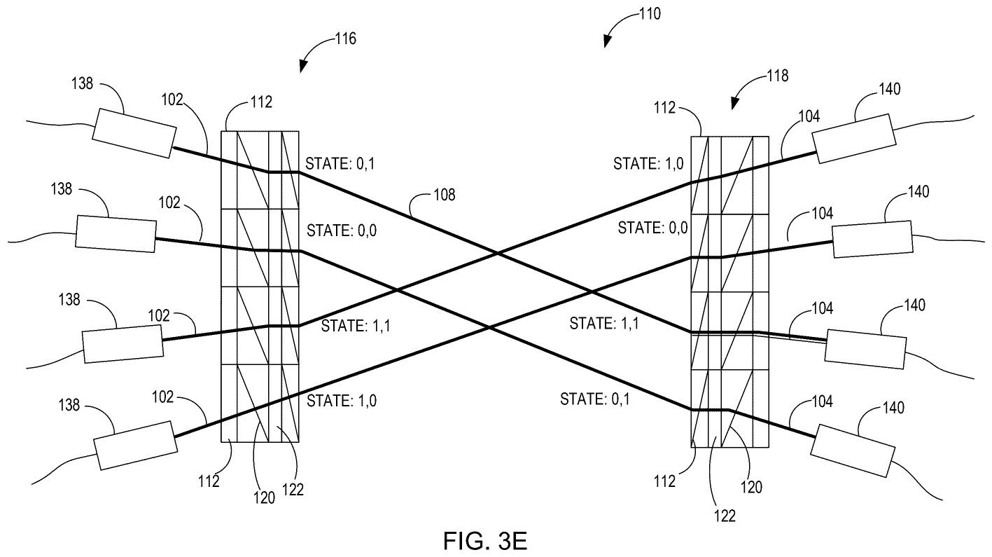

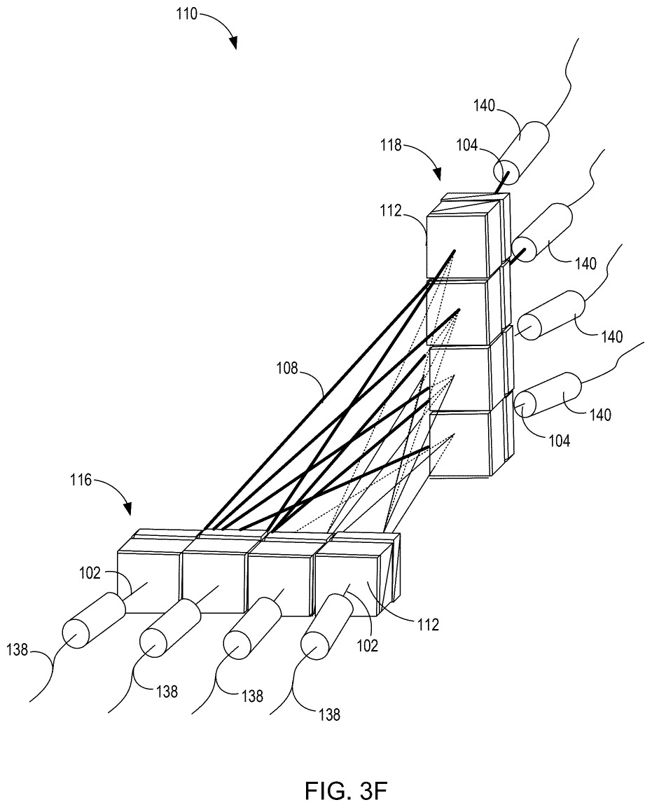

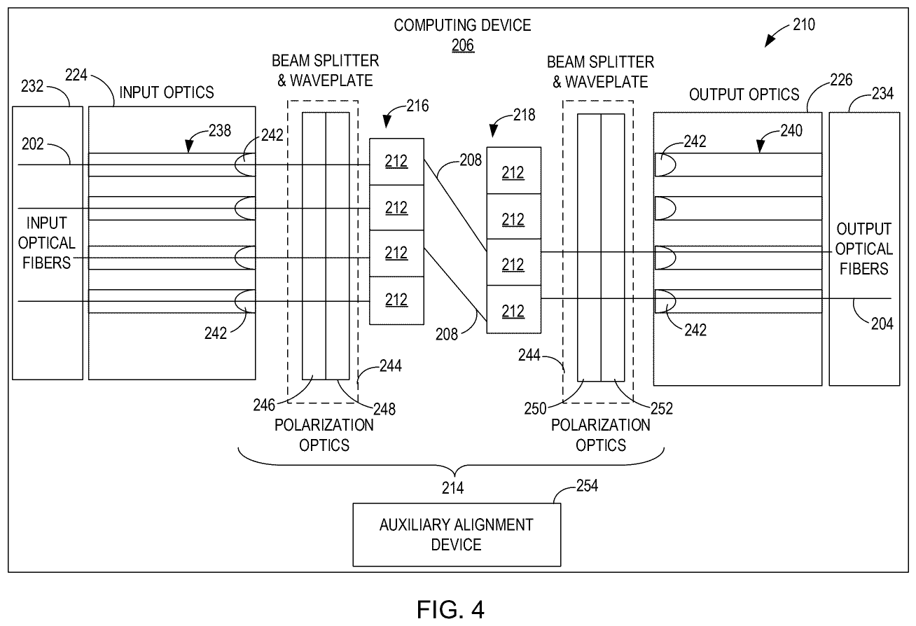

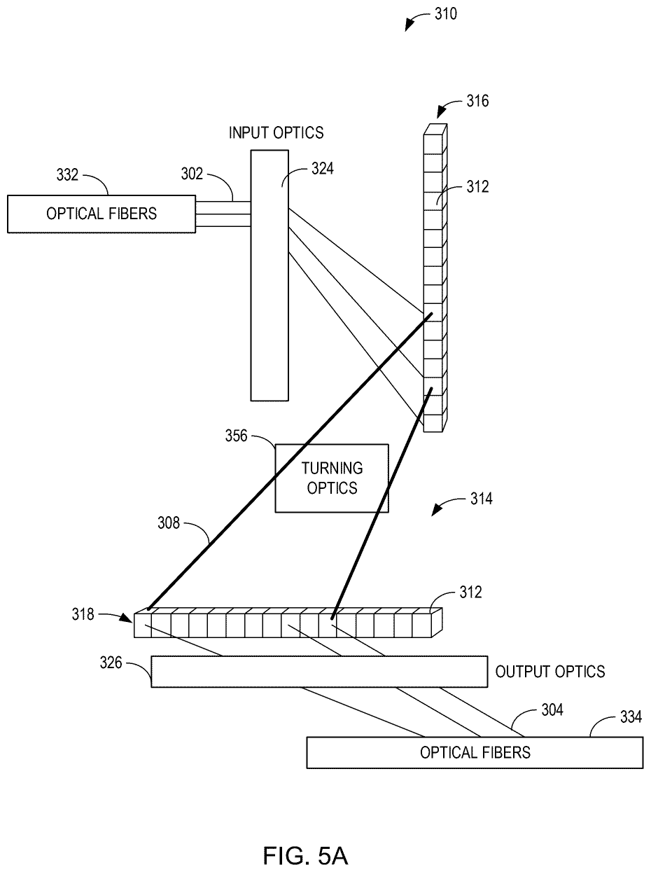

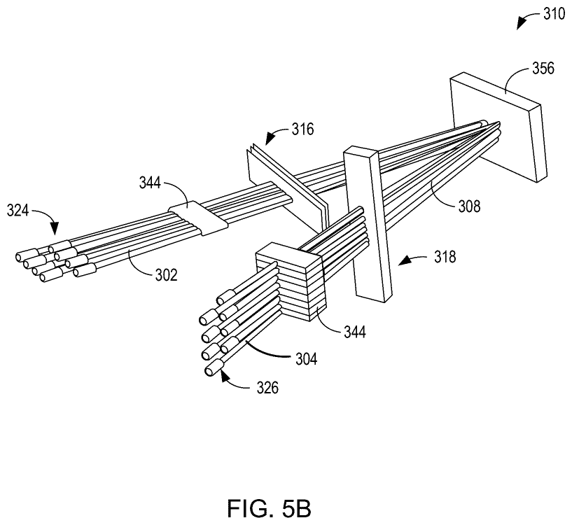

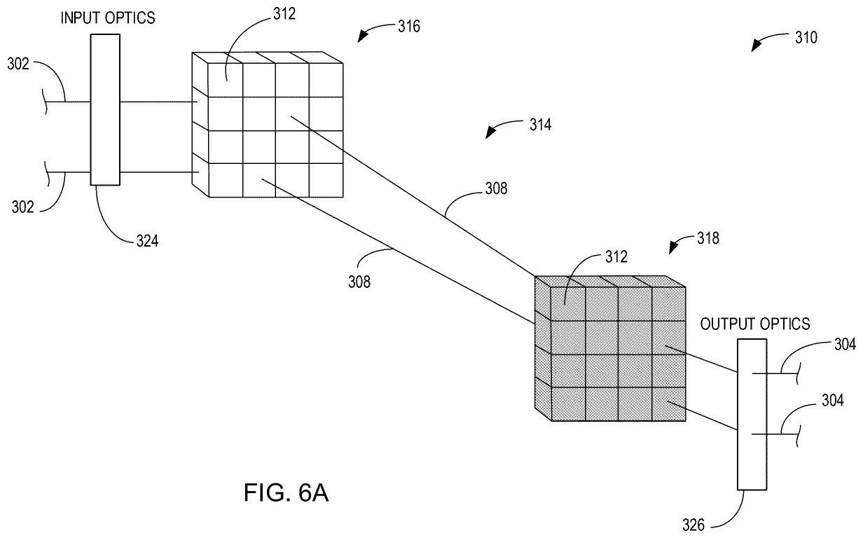

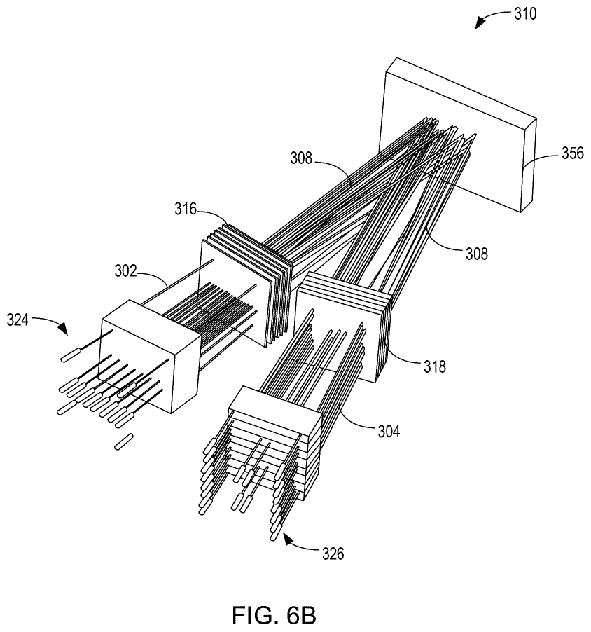

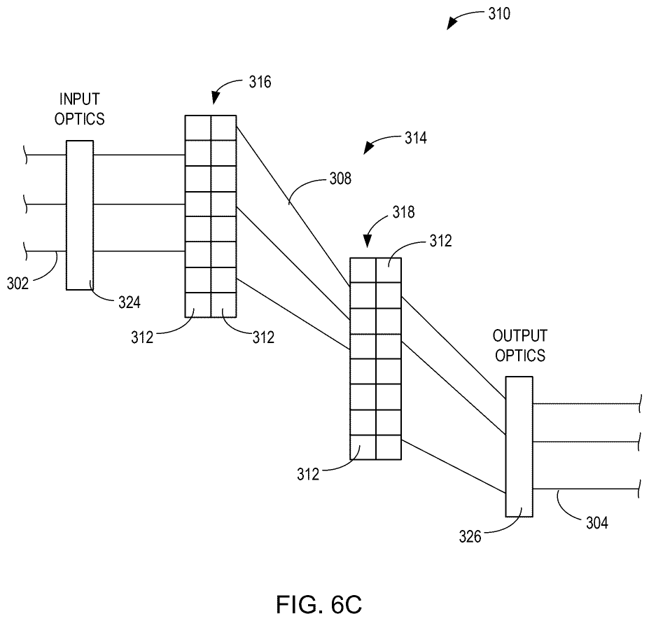

Various examples of optical circuit switches 110, 210, 310 including features of the present disclosure are show schematically in FIGS. 2-6C. In particular, FIG. 2 is a schematic drawing of an example of an optical circuit switch 110 including switching arrays 116, 118 of the switching blocks 112. FIGS. 3A-3C are schematic drawings of arrangements of switching blocks 112 of the optical circuit switch 110 for switching a single fiber. FIGS. 3D-3F are schematic drawings of optical circuit switches 110 for switching multiple (e.g., four) fibers. FIG. 4 is a schematic drawing of a computing device 206 including an optical circuit switch 210. FIGS. 5A-6C are additional schematic drawings of optical circuit switches 310 showing various configurations of arrays 316, 318 of switching blocks 312.

As shown in FIGS. 2 and 3D-3F, the optical circuit switches 110 comprises the digital switching blocks 112 arranged to form fiber or switching arrays 116, 118. As shown in FIGS. 5A-6C, the fiber or switching arrays 116, 118 can be either one-dimensional (1-D) arrays comprising switching blocks 112 arranged in series or multi-dimensional arrays, such as a two dimension (2-D) array, comprising switching blocks 112 arranged as a rectangle or square. In some examples, as previously described, the switching blocks 112 of the present disclosure can comprise a 1×2^{N} switching block 112 configured for providing a digital LC port switching technology.

As shown in FIGS. 2 and 3A-3C, the switching blocks 112 comprise birefringent wedges 120 that direct light beams based on polarization in combination with liquid crystal (LC) cells 122 that control the polarization. Each LC cell 122 and birefringent wedge 120 combination can offer 1×2 switching. Thus, N combinations of birefringent wedges 120 and LC cells 122 will have 2^{N} states. As shown in FIGS. 2 and 3A-3C, the LC cells 122 and the birefringent wedges 120 can be arranged in series with at least one birefringent wedge 120 positioned between adjacent LC cells 122. Also, as shown in FIGS. 3B and 3C, in some examples, the birefringent wedges 120 of the switching blocks 112 can be provided in an alternating orientation with vertices of the birefringent wedges 120 pointing in different directions. For example, adjacent birefringent wedges 120 can be rotated by 180 degrees relative to one another. It is believed that alternating the orientation of the birefringent wedges 120 can lessen deflection for switching blocks 112 with multiple stages (i.e., switching blocks 112 that include multiple LC cells 122 and/or birefringent wedges 120). However, while alternating the orientation of the birefringent wedges 120 may lessen the deflection, a switching block 112 comprising the alternating birefringent wedges 120 will not produce M beams uniformly distributed about the incident direction. Accordingly, in some examples, another way to produce uniform distribution is to use birefringent wedges 120 made of or comprising an isotropic material. Another approach may be to replace a birefringent wedge 120 with a birefringent wedge pair whose optic axes are orthogonal. This configuration can be referred to as a Wollaston polarizer, which has a property that, for a normally incident beam, the beam is split into two orthogonally polarized beams whose deviations are symmetric with respect to the incident direction of propagation. To obtain the same angular deviation between the two beams as is achieved in the single wedge case, the wedge angle for each member of the Wollaston pair can be half of that for the single wedge design.

With continued reference to FIGS. 2 and 3A-3C, in some examples, each of the digital switching blocks 112 is a 1×2^{N} digital switching block, in which N is an integer value equal to a number of the LC cells 122 or a number of the birefringent wedges 120 for one of the digital switching blocks 112. For example, as shown in FIG. 2, the digital switching blocks 112 can comprises four (4) LC cells 122 interspersed with four (4) birefringent wedges 120. Accordingly, the digital switching block 112 can be a 1×2⁴ or 1×16 digital switching block 112, meaning that an input beam can be selectively directed to one or more of sixteen (16) potential output ports or locations.

Regarding terminology and as referred to herein, a 1×M optical switch comprises one input fiber (or port) and M output fibers (or ports) to which the input can be selectively routed. An M×N multicast switch includes M input fibers or ports and N output fibers or ports. A signal provided to one of the M input ports can be selectively routed to one or more of the N output ports. For the M×N switch, M and N are integer values greater than or equal to 1. In some examples, as described in further detail herein, an M×N switch can also comprise M splitters, which can be configured to provide wavelength channels or components of an input signal to one of the M inputs of the M×N optical switch.

As previously described, the LC optical circuit switching portions 114 of each optical circuit switch 110 comprise multiple digital switching blocks 112, which provide 1×2^{N} switching, and which are arranged to provide an M×N′ optical circuit switch 110 with full switching functionality. In particular, the optical circuit switch 110 is configured to provide selective switching for M input beams 102, which are processed by the optical circuit switch 110 to provide N′ output beams. The M×N′ optical circuit switch 110 desirably has the capability to switch any one of the M input beams 102 received at input ports of the optical circuit switch 110 to any of the N′ output ports.

In some examples, the number (N) of the plurality of LC cells 122 and/or a number of the plurality of birefringent wedges 120 for one of the switching blocks 112 is less than the number (N′) of wavelength components of the output beam (e.g., N<N′). Furthermore, in some examples, the M×N′ switch can be a rectangular array in which M<N′. For example, the optical circuit switch 110 can be 16×32, 32×64, 64×512 or any other convenient input and output configuration. In other examples, the optical circuit switch 110 can be configured to provide a square array, with M=N′. For example, the optical circuit switch 110 can be configured to provide full switching functionalities for at least a switch having 32×32 port count applications. In other examples, the optical circuit switch 110 can be configured to provide full switching functionalities for up to 512×512 port count applications.

Optical switching for optical circuit switches 110 for one and multiple fibers is schematically shown in FIGS. 3B-3F. For example, FIG. 3B shows an optical circuit switch 110 comprising a switching block 112 comprising the LC cells 122 and the birefringent wedges 120. In FIG. 3B, the LC cells 122 and birefringent wedges 120 are positioned to provide two-dimensional switching, in which the switching block 112 selectively directs the input beam 102 from a collimator (e.g., a collimator of an input collimator array 138) to one or multiple locations or states. For example, the input beam 102 can be directed to one of a first state (shown by reference number 0,0), a second state (shown by reference number 1,0), a third state (shown by reference number 0,1), or a fourth state (shown by reference number 1,1). FIG. 3C shows another example of an optical circuit switch 110 including the switching block 112 for selectively directing a single input beam 102 from a collimator (e.g., a collimator of the input collimator array 138) to one of four states (state 1,1, state 1,0, state 0,1, and state 0,0) arranged in one-dimension.

FIGS. 3D-3F show optical circuit switches 110 for switching multiple (e.g., four) fibers using a first group or switching array 116 of switching blocks 112 and a second group or switching array 118 of switching blocks 112. As shown in FIGS. 3D and 3E, input beams 102 are provided from collimators of an input collimator array 138 to the first fiber or switching array 116 of switching blocks 112. As in the previous example, each switching block 112 can selectively direct the input beams 102 to one or more of four locations, such as to one of the four switching blocks 112 of the second switching array 118. In FIG. 3D, the switching blocks 112 of the first switching array 116 direct the beams substantially horizontally from the first switching array 116 to horizontally aligned switching blocks 112 of the second switching array 118. The switching blocks 112 of the second switching array 118 then direct output beams 104 substantially horizontally to collimators of an output collimator array 140 that are horizontally aligned with each switching block 112. By contrast, in FIG. 3E, the switching blocks 112 of the first switching array 116 direct beams to other switching blocks 112 of the second switching array 118 (i.e., switching blocks 112 that are not horizontally aligned with the first switching array 116). For example, as shown in FIG. 3E, a top switching block 112 of the first switching array 116 directs a beam 108 to a switching block 112 that is near a bottom position of the second switching array 118. As in FIG. 3D, the switching blocks 112 of the second switching array 118 then direct the optical beams (e.g., output beams 104) to the collimators of the output collimator array 140. FIG. 3F shows another example of an optical circuit switch 110 including the collimators of the input collimator array 138, first switching array 116 of switching blocks 112, second switching array 118 of switching blocks 112, and collimators of an output collimator array 140. As in previous examples, the switching blocks 112 of the first switching array 116 are configured to selectively direct optical beams (e.g., switched beams 108) to the four switching blocks of the second switching array 118. However, in FIG. 3F, the first switching array 116 and the second switching array 118 are provided in a different configuration or orientation from one another. Specifically, as shown in FIG. 3F, the first switching array 116 is in a horizontal configuration and the second switching array 118 is a vertical orientation.

With reference again to FIG. 2, the optical circuit switches 110 of the present disclosure can further comprise input components, ports, or optics 124 and output components, ports, or optics 126 for directing optical signals to and from the optical circuit switch 110. More specifically, FIG. 2 shows an optical circuit switch 110 comprising input optics 124 that transmit an input signal (e.g., input beams 102) from input optical fibers 132 or an optical waveguide to the optical circuit switch 110. The output optical optics 126 can transmit output signals from the optical circuit switch 110 to output optical fibers 134 or an output waveguide. As described in further detail in connection with FIG. 4, in some examples, the input components, ports, or optics 124 comprise a collimator array and/or lens(es) for properly aligning the input beams 102 with the optical circuit switch 110. In a similar manner, the output components, ports, or optics 126 can comprise a collimator array and lens(es) for directing the output beams 104 from the optical circuit switch 110 to the output optical fibers 134. For example, each fiber or collimator of a collimator array can include an individual lens for directing an input beam 102 to the optical circuit switch 110. In examples, the optical circuit switch 110 can comprise input components or ports for M inputs and output components or ports for N′ outputs, wherein M and N′ are any non-zero integer value. It is noted that FIG. 2 includes only four (4) input ports and four (4) output ports for schematic purposes. However, the optical circuit switch 110 of the present disclosure generally comprises many more than four input ports and output ports. For example, as previously described, the optical circuit switch 110 of the present disclosure can include 16, 32, 64, 128, 512, or more input ports and/or output ports, in accordance with the present disclosure.

In some examples, the input components, ports, or optics 124 are configured to direct the input beam(s) 102 through the optical circuit switch 110 and to particular locations on the fiber or switching array 116. The optical circuit switch 110 can also include or be connected to polarization diversity control devices or optics. The diversity control devices or optics can comprise a beam dispersion device, beam displacer, or beam splitter for separating a received input beam 102 into two beams with an orthogonal linear state of polarization and/or a waveplate for rotating one of the two beams (e.g., rotation by 90 degrees) providing linear polarization for the two beams. In a similar manner, the optical circuit switch 110 can also include polarization diversity control optics positioned, for example, after the switching array 118 for providing polarization and/or combining output beams 104.

In operation, as shown in FIG. 2, the input beams 102 are received by the input components, ports, or optics 124 of the optical circuit switch 110. The input beams 102 pass through the input optics 124 and are switched by the first switching array 116. Specifically, the first switching array 116 can be configured to selectively direct resulting or switched beams 108 from the first switching array 116 to the second switching array 118. The second switching array 118 then directs output beams 104 to the output components, ports, or optics 126.

In some examples, the optical circuit switches 110 disclosed herein are configured for use in digital LC circuits. Use in LC circuits should be acceptable because similar switching devices have been used in wavelength selective switching applications with success. In other examples, the optical circuit switch 110 of the present disclosure can be implemented with an LCOS device and/or an LFT-LCD device configured to achieve similar functions.

### Computing Device and Optical Circuit Switch

FIG. 4 shows an optical circuit switch 210 including features of the present disclosure. The optical circuit switch 210 is integrated with a computing device 206. As previously described, optical switches 210 of the present disclosure can be used with computing devices 206, such as a tensor processing unit (TPU) and/or graphical processing unit (GPU) in a data center and/or for supercomputers. In some examples, the computing device 206 can be used for machine learning and artificial intelligence (ML/AI) applications.

The computing device 206 can comprise optical fibers 232, 234, which can be connected between one or more optical circuit switches 210. For example, as shown in FIG. 4, input optical fibers 210 or an input optical waveguide direct optical input beams 202 or signals to the optical circuit switch 210. The computing device 206 also includes the output optical fibers 234 or an optical waveguide that direct output beams 204 away from the optical circuit switch 210 and to other electronic devices or components of the computing device 206.

As in previous examples, the optical circuit switch 210 shown in FIG. 4 includes optical components, ports, or optics 224 for directing input optical beams 202 from the input optical fibers 232 to the optical circuit switch 210. In a similar manner, the optical circuit switch 210 also includes output components, ports, or optics 226 for directing an output beam 204 away from the optical circuit switch 210 and to the other devices or systems of the computing device 206.

As shown in FIG. 4, as in previous examples, the optical circuit switch 210 further comprises the liquid crystal (LC) optical circuit switching portion 214, which includes fiber or switching arrays 216, 218. The arrays 216, 218 are formed from multiple digital switching blocks 212. More specifically, the circuit switching portion 214 can comprise the input switching array 216, which is positioned to receive the input beams 202 from the input optical fiber 232, and the output switching array 218, which is configured to provide the output beam 204 to the output optical fiber 234. As in previous examples, the digital switching blocks 212 are formed from or comprise liquid crystal (LC) cells 122 (shown in FIGS. 2 and 3A-3C). The digital switching blocks 212 can also comprise the birefringent wedges 120 (shown in FIGS. 2 and 3A-3C) that direct the input beam 202 based on polarization. As in previous examples, the plurality of birefringent wedges 120 can be disposed between adjacent LC cells 122. Also, the digital switching blocks 212 can comprise 1×2^{N} digital switching blocks, with N being an integer value equal to a number of the plurality of LC cells 122 and/or a number of the plurality of birefringent wedges 120 for one of the switching blocks 212.

In some examples, the input components, ports, or optics 224 are provided for manipulating the input signal (e.g., input beams 202) received from the input optical fibers 232 prior to providing the input signal to the input switching array 216 of the optical circuit switch 210. As shown in FIG. 4, the input components 224 can comprise an input collimator array 238 and lens 242 for directing the input beams 202 to the optical circuit switch 210.

As shown in FIG. 4, the optical circuit switch 210 can also include polarization diversity control optics 244 positioned, for example, between the input optics 224 and the first switching array 216. The polarization diversity control optics 244 can be configured to separate the input beams 202 into multiple beams and to provide linear polarization for the input beams 202. For example, the polarization diversity control optics 244 can comprise a beam dispersion device, splitter, or displacer 246 configured to spatially separate the input beams 202 into two beams with an orthogonal linear state of polarization. The polarization diversity control optics 244 can also include a waveplate 248 for rotating one of the two beams (e.g., by 90 degrees) so that the two beams have the same linear polarization.

In some examples, the polarization diversity control device or optics 244 can be configured to control polarization of the signals and minimize polarization-dependent effects. For example, the polarization diversity control optics 244 can be configured to transmit a linear polarization state to the plurality of LC cells 122 and birefringent wedges 120 of the switching blocks 212. In some examples, the polarization diversity control device or optics 244 also optionally includes a variable optical attenuator, such as a liquid crystal variable optical attenuator array, to control optical signal power for input signals. Examples of such variable optical attenuator devices will be known to those skilled in the art and can be implemented in the optical circuit switch 210 along with other components of the polarization diversity optics described above and shown in FIG. 4.

As will be appreciated by those skilled in the art, the polarization diversity control device or optics 244 can be configured to control polarization of light in the fiber optic networks, which does not generally occur for such networks. Instead, components of a fiber optic system can cause polarization modification due to features of the optical components in the optical circuit switch 210 (e.g., optical amplifiers, gain equalizers, attenuators) and/or from strain birefringence occurring in the fiber(s). The polarization diversity control device or optics 244 shown in FIG. 4 can be provided to counteract such polarization modifications. Thus, the polarization diversity control device or optics 244 of the optical circuit switch 210 described herein provide a well-defined, controlled polarization for the optical beam prior to entering the optical circuit switch 210. In addition, the controlled signal can then be manipulated by the birefringent wedges 120 and LC cells 122 of the switching blocks 212. In some examples, the optical circuit switch 110 can also include at least one liquid crystal (LC) based switch device or switch engine. For example, the switch apparatus can be a liquid-crystal-on-silicon (LCoS) switch assembly.

The optical circuit switch 210 further comprises the output components, ports, or optics 226 for providing the output beams 204 from the second switching array 218 to the output optical fibers 234. The output components, ports, or optics 226 can include an output collimator array 240 and lens(es) 242 for directing the optical signal or output beams 204 from the optical circuit switch 210 to the output optical fibers 234.

The optical circuit switch 210 further comprises polarization diversity control optics 244 for the output beams 204. The polarization diversity control optics 244 can comprise a second waveplate 250 configured to rotate some of the output beams 204 thereby providing polarization to the output signal (e.g., so that the output beams 204 are in an orthogonal linear state of polarization). The polarization diversity control optics 244 can also include a second or output beam dispersion device, splitter, or beam displacer 252 for combining or reducing separation between the output beams 204.

Generally, it is believed that the optical circuit switches 110, 210, 310 of the present disclosure avoid introducing unwanted diffraction orders into the optical signal. Furthermore, as described previously, the optical circuit switches 110, 210, 310 do not include moving mechanical parts. Therefore, it is expected that the optical circuit switches 110, 210, 310 are stable and may not require an auxiliary or separate alignment device. However, in some examples and as shown in FIG. 4, the optical circuit switch 210 can include an alignment device 254 disposed in the optical path of the optical circuit switch 210. For example, an alignment process provided by the optical alignment device 254 can be performed for the optical circuit switch 210 during fabrication, such that alignment is fixed once the optical circuit switch 210 is sealed. In other examples, the optical circuit switch 210 can be configured so that alignment can be adjusted and readjusted during use if, for example, an incident angle changes after the stabilization process.

More specifically, in some examples, the optical alignment adjustment device 254 can be configured to account for and correct component tolerance in the input beam 202 and/or the output beam 204. For example, the optical alignment adjustment device 254 can comprise thin-film transistor (TFT) display or liquid crystal display (LCD) device. In some examples, the TFT-LCD can comprise a “soft” display (having software generated indications), which can provide a flexible display environment. In other examples, other types of panel elements (including for example thin-film transistor (TFT)-based devices, white-light LEDs, plasma displays, cathode ray tubes, etc.) may be used. As will be appreciated by those skilled in the art, each of these alternate panel devices may have its own specific parameters other than or in addition to those described above. Hence, the invention is in no way limited to the parameters or display devices described above.

In other examples, as described in connection with FIG. 8, the optical circuit switches 110, 210, 310 of the present disclosure can comprise an LCOS switch device for addressing alignment issues and/or for correcting other inaccuracies in optical signals. The LCOS device can function as follows. The liquid-crystal-on-silicon (LCoS) switch can be provided with a phase grating profile and with addressable pixels, which are liquid crystal based. The LCOS switch can selectively direct first-order diffracted beams of the optical channels for output to selected output ports. Furthermore, in some examples, an LCOS panel can be a phased-array panel configured to provide switching and independently controlled attenuation of whatever optical signal is directed to each of the output ports of the optical circuit switch 110.

In some examples, an LCOS phased-array panel can be configured to aim incident beams of an optical signal having a single known polarization state by controlling the phase of light waves reflecting from a two-dimensional surface by means of adjustable liquid crystal (LC) surface elements disposed on the device surface. Groups of pixels operating together on the LCOS phased array panel act as the individual beam-steering devices. Beneficially, the desired steering can be performed without the need for moving parts by introducing a suitable phase delay with each LCOS beam-steering device relative to the other beam-steering devices. High-resolution LCOS panels, such as panels having 1920×1028 pixels, have adequate resolution to perform phased-array steering of a large number of input optical signals, and can therefore readily be configured for use as a 1×N array of beam steering devices in lieu of a fiber array.

### Single Dimension and Multi-Dimensional Fiber Arrays

FIGS. 5A-6C are schematic drawings of examples of optical circuit switches 310 for passing optical signals, such as input beams 302, from input optical fibers 332 to output optical fibers 334. As in previous examples, the input beams 302 can pass through input components, ports, or optics 324, such as a collimator array, and/or polarization diversity control optics 344 prior to switching the input beams 302. Similarly, switched or output beams 304 can pass through polarization diversity control optics 344 and/or output components, ports, or optics 326, such as an output collimator array, prior to pass into output optical fibers 334. As previously described, switching blocks 312 of the optical circuit switch 310 of the present disclosure are arranged to form fiber or switching arrays 316, 318 for receiving, processing, and outputting the optical beam or signal. Examples of optical circuit switches 310 including different examples of the fiber or switching arrays 316, 318 are shown in FIGS. 5A-6C. As shown in FIGS. 5A-6C, the switching blocks 312 can be arranged to form one-dimensional arrays (in FIGS. 5A and 5B) or multidimensional arrays (in FIGS. 6A-6C).

More specifically, as shown in FIGS. 5A and 5B, the optical circuit switch 310 comprises a first or input switching array 316 formed from a plurality of switching blocks 312. As in previous examples, the switching blocks 312 can comprise liquid crystal cells 122 (shown in FIGS. 2 and 3A-3C) configured to control polarization of input beams 302, which are arranged in series. The switching blocks 312 also include the plurality of birefringent wedges 120 (shown in FIGS. 2 and 3A-3C) that direct the input beams 302 based on polarization. As in previous examples, one or more of the birefringent wedges 120 can be disposed between adjacent LC cells 122.

As shown in FIGS. 5A and 5B, the input switching array 316 and the output switching array 318 are one-dimensional (1D) arrays, in which the switching blocks 312 are arranged side-by-side, in series. Specifically, as shown in FIG. 5A, the switching arrays 316, 318 can comprise sixteen (16) blocks arranged in a 1×16 or 16×1 configuration. As previously described, the switching blocks 312 can be 1×2^{N} blocks formed from four (4) LC cells and four (4) birefringent wedges. Therefore, each block can have 2⁴ or sixteen (16) possible output positions, meaning that each switching block 312 can selectively pass a signal to any or all of the switching blocks 312 of the output switching array 318.

As shown in FIGS. 5A and 5B, the switching arrays 316, 318 can be configured so that the input beams 302 are received by and pass through one of the digital switching blocks 312 of the input switching array 316, thereby providing a switched beam 308. The switched beam 308 can pass from the input switching array 316 to one or multiple switching blocks 312 of the output switching array 318. For example, as shown in FIG. 5A, the switched beam 308 passes to a middle switching block 312 (i.e., a block that is seven from the right-most switching block 312 as shown in FIG. 5A). In other examples, the switched beam 308 can selectively pass from the input switching array 316 to any other switching block 312 of the output switching array 312.

In some examples, the two switching arrays 316, 318 can be co-planar. In such cases, turning optics 356 can be used for directing signals between the switching arrays 316, 318. For example, the turning optics 356 can comprise a mirror (shown in FIG. 5B) for directing the switched beams 308 from the first or input switching array 316 to the second or output switching array 318. The turning optics 356 can also comprise a beam-turning reflector, a polarization beam splitter, and/or polarization rotators. The beam-turning reflector can be disposed so as to intercept the signals emanating from switching blocks 312 of the input switching array 316 and turn their directions of propagation by an appropriate amount, such as by approximately 90 degrees, toward the output switching array 318. In other examples, the switching arrays 316, 318 can be in different planes or spaced apart according to some other arrangement or configuration.

In some examples, the polarization beam splitter of the turning optics 356 can be disposed such that light of sub-signals emanating from other switching blocks 312 of the input switching array 316 pass there through without deflection. Also, as previously described, the optical circuit switch 310 can include the polarization diversity control optics 344 (shown in FIG. 5B) for converting input beams 302 to linear polarization and/or for converting output beams 304 to the orthogonal linear state of polarization.

FIGS. 6A and 6B show another example of an optical circuit switch 310 including features of the present disclosure. As in previous examples, the optical circuit switch 310 in FIGS. 6A and 6B comprises the input switching array 316 and the output switching array 318 formed from the plurality of switching blocks 312. The optical circuit switch 310 also includes the input components, ports, or optics 324, such as a collimator array, for receiving input beams 302 from input optical fibers 332 (not shown in FIGS. 6A and 6B) and directing the input beams 302 to the input switching array 316. The optical circuit switch 310 can also include the output components, ports, or optics 326, such as a collimator array, for guiding output beams 304 from the output switching array 318 to output fiber optics 334 (not shown in FIGS. 6A and 6B).

Unlike in the previous example, the input switching array 316 and the output switching array 318 of FIGS. 6A and 6B are square shaped two-dimensional arrays. Specifically, as shown in FIG. 6A, the switching arrays 316, 318 can comprise sixteen (16) blocks 312 arranged in a 4×4 pattern. As shown in FIGS. 6A and 6B, input beams 302 selectively pass through the switching block 312 of the input switching array 316 (e.g., through a switching block 312 near the top left of the input switching array 316) and a resulting switched beam 308 is received by a switching block 312 located at another position of the output switching array 318. In other examples, as previously described, a signal (e.g., a switching beam 308) from a switching block 312 of the input switching array 316 can pass to any or all of the switching blocks 312 of the output switching array 318.

FIG. 6C shows another example of an optical switch 310 including multi-dimensional fiber or switching arrays 316, 318. As in previous examples, the optical circuit switch 310 in FIG. 6C comprises the input switching array 316 and the output switching array 318 formed from the plurality of switching blocks 312. The optical circuit switch 310 also includes the input components, ports, or optics 324 for receiving an input signal, such as input beams 302, and guiding the input beams 302 to the input switching array 316. The optical circuit switch 310 can also include the output components, ports, or optics 326 for guiding output beams 304 from the output switching array 318 to output optical fibers 334 (not shown in FIG. 6C).

Unlike in previous examples, the switching arrays 316, 318 in FIG. 6C are rectangular in shape with a 2×8 or 8×2 configuration. Specifically, the input switching array 316 is oriented vertically, with two columns of eight (8) switching blocks 312. The output switching array 318 is oriented horizontally, with two rows of eight switching blocks 312. As in previous examples, the switched beam 308 can pass from a switching block 312 of the input switching array 316 to any or all of the switching blocks 312 of the output switching array 318. As in previous examples, the optical circuit switch 310 of FIG. 6C can also include the turning optics 356 so that the switching arrays 316, 318 can be provided in a planar configuration. The optical circuit switch 310 of FIG. 6C can also comprise the polarization diversity control optics 344 (not shown in FIG. 6C) for converting to linear polarization, as previously described.

### Optical Beam Processing Method

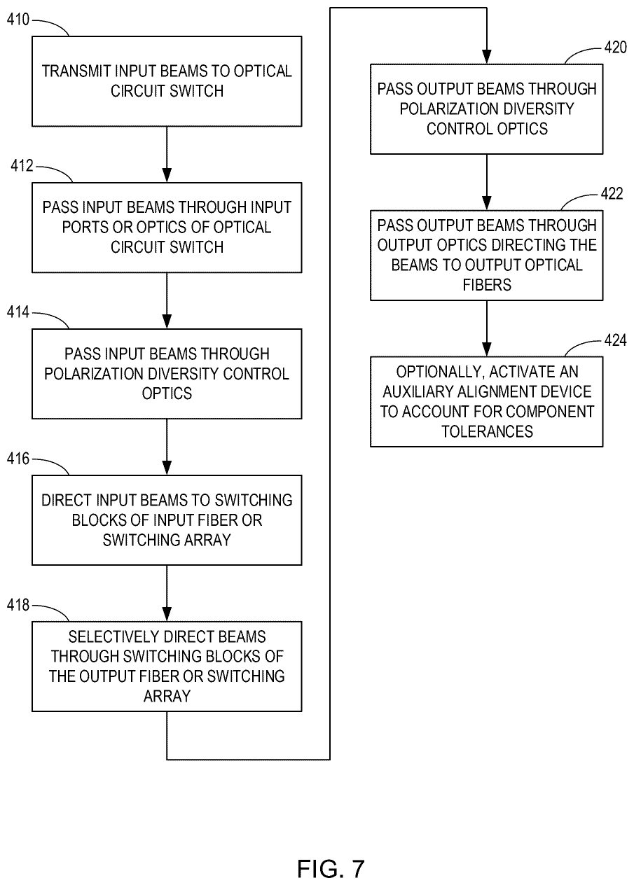

The present disclosure is also directed to a method for processing an input signal comprising input beams 102, 202, 302 using any of the optical circuit switches 110, 210, 310 of the present disclosure. FIG. 7 is a flow chart showing steps of the method for processing the input signal. As shown in FIG. 7, the method comprises a step 410 of transmitting input beams 102 from a source (e.g., optical fibers 132 or a waveguide) to an optical circuit switch 110 comprising switching blocks 112. As previously described, the switching blocks 112 can comprise a plurality of liquid crystal (LC) cells 122 configured to control polarization of the input beams 102 arranged in series and a plurality of birefringent wedges 120 that direct the input beams 102 based on polarization disposed between adjacent LC cells 122. As previously described, the digital switching blocks 112 can comprise 1×2^{N} digital switching blocks, with N being an integer value equal to a number of the plurality of LC cells 122 or the number of birefringent wedges 120 for one of the switching blocks 112, 312.

In some examples, the optical circuit switch 110 can be an M×N′ switching apparatus comprising M input ports configured to receive wavelength channels of the input beams 102 and N′ output ports configured to receive wavelength channels from switching blocks 112 of the optical circuit switch 110, wherein M and N′ are integer values greater than or equal to 1.

At step 412, the method can further comprise passing the input beam 102 through input components, ports, or optics 124 of the optical circuit switch 110. The input component, ports, or optics 124 can include a collimator array 238 and/or optical power devices, such as lens(es) 242, (shown in FIG. 4) that provide spacing for the input beams 102 and/or direct the input beams 102 towards switching blocks 112 of the input switching array 116.

At step 414, after the input beams 102 pass through the input components, ports, or optics 124, the method can further comprise passing the input beams 102 through the polarization diversity control device or optics 244. As previously described, the polarization diversity control device or optics 244 can include the beam displacer 246 (e.g., a beam dispersion device or splitter) for separating the input beams 102 into two beams with orthogonal linear state of polarization. The polarization diversity control optics 244 or device can also include a waveplate 248 (e.g., a transflective polarizing element or polarization diversity optics) for rotating one of the beams (e.g., by about 90 degrees) in order to provide linearized polarization for the input beams 102.

After the input beams 102 pass through the input optics 124 and the polarization diversity control device or optics 244, the input beams 102 are directed to one or more of the switching blocks 112 of the optical circuit switch 110 for switching the optical signal. For example, at step 416, the input beams 102 can be directed to one or more switching blocks 112 of the first or input fiber or switching array 116, such as the one-dimensional fiber array (shown in FIGS. 5A and 5B) or a two-dimensional fiber or switching array (shown in FIGS. 6A-6C). As previously described, the switching blocks 112 of the input switching array 116 are configured to selectively pass beams (e.g., resulting or switched beams 308) from the input switching array 116 to one or more switching blocks 112 of a second or output fiber or switching array 118 for switching the optical signal. For example, a beam 108 can pass from a location on the input switching array 116 to another location on the output switching array 118.

At step 418, the method can further comprise passing the resulting or switched beams 308 through the selected switching blocks 112 of the output switching array 118. The switching blocks 112 of the output switching array 118 can selectively direct output beams 104 to output optics 126 and/or output optical fibers 134. For example, at step 420, output beams 104 can be guided from the output switching array 118 to a polarization diversity control device or optics 244. The polarization diversity control optics 244 can include a waveplate 250 for turning some of the beams (e.g., by about 90 degrees) so that beams of the output signal are polarized (e.g., having an orthogonal linear state of polarization). The polarization diversity control optics 244 can also include a beam displacer 252 oriented to combine beams to form the output beams 104.

At step 422, the output beams 104 can next pass through the output components, ports, or optics 126 for directing the output beams 104 to output optical fibers 134. For example, the method can comprise passing the output beams 104 through a collimator array 240 for providing beams that are parallel and/or through an optical power device or lens(es) 242 (shown in FIG. 4) to guide the output beams 104 to the output optical fibers 134.

At step 424, the method can also comprise activating an optical alignment adjustment device 254 (shown in FIG. 4) to account for component tolerance in the input and/or output beam.

### LCOS Optical Switch Device

In some examples, optical switching can be provided by Liquid Crystal on Silicon (LCoS) chips or devices rather than by the previously described optical switching blocks 112, 212, 312. FIG. 8 is a schematic drawing of an optical circuit switch 510 comprising LCOS device(s) for optical switching. As shown in FIG. 8, the optical circuit switch 510 comprises a first or input collimator array 538, a second or output collimator array 540, LCoS chips or devices 558, 560 for providing the optical switching, and turning optics 556 (e.g., mirrors) for directing beams between the LCoS chips or devices 558, 560. In some examples, the liquid-crystal-on-silicon (LCoS) chips or devices 558, 560 can comprise a phase grating profile with addressable pixels, which are liquid crystal based. In examples, a first LCoS chips or device 558 can be configured to selectively direct first-order diffracted beams to selected locations or pixels of the second LCOS chip or device 560. The second LCOS chip or device 560 can be configured to direct beams to a collimator array 540 of the LCOS chip or device 560. In some examples, an LCOS panel can be a phased-array panel configured to provide switching and independently controlled attenuation of whatever optical signal is directed to each of the collimator array 540 of the optical circuit switch 510.

In some examples, an LCOS phased-array panel can be configured to aim incident wavelength components of an optical signal having a single known polarization state by controlling the phase of light waves reflecting from a two-dimensional surface by means of adjustable liquid crystal (LC) surface elements disposed on the device surface. Groups of pixels operating together on the LCOS phased array panel act as the individual beam-steering devices. Beneficially, the desired steering can be performed without using moving parts by introducing a suitable phase delay with each LCOS beam-steering device relative to the other beam-steering devices. High-resolution LCOS panels, such as panels having 1920×1028 pixels, have adequate resolution to perform phased-array steering of a large number of input optical signals, and can therefore readily be configured for use as a 1×N array of beam steering devices in lieu of a fiber array.

In operation, as shown in FIG. 8, an input signal (e.g., input beams 502) passes through the input collimator array 538 to a first or input LCOS chip or device 558. As with the switching blocks 112, 212, 312 in previous examples, the LCOS chip or device 558 is configured to selectively direct resulting or switched beams 508 from the first LCOS chip or device 558 to one or more states or locations. As shown in FIG. 8, the resulting or switched beams 508 are reflected by turning optics 556, such as mirrors, to the second or output LCOS chip or device 560. The output LCOS chip or device 560 is configured to receive the reflected or switched beams 508 and, based on the received beams 508, selectively direct output beams 504 from the output LCOS chip or device 560 to collimators of the collimator array 540. As in previous examples, the collimator array 540 and/or other output optics can direct the output beams 504 to the output optical fibers 534.

It is to be understood that the invention may assume various alternative variations, except where expressly specified to the contrary. It is also to be understood that the specific devices illustrated in the attached drawings, and described in the specification, are simply exemplary embodiments of the invention. Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope thereof. For example, it is to be understood that the present invention contemplates that, to the extent possible, one or more features of any embodiment can be combined with one or more features of any other embodiment. The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

The invention claimed is:

1. An optical switching apparatus for optical switching of input beams from a plurality of optical fibers, the optical switching apparatus comprising:
a plurality of digital switching blocks arranged in series or as a multi-dimensional array, the plurality of digital switching blocks comprising:
a plurality of liquid crystal (LC) cells arranged in series configured to control polarization of the input beams, and
a plurality of birefringent wedges that direct the input beams based on polarization, wherein one or more of the plurality of birefringent wedges is disposed between adjacent LC cells of the plurality of LC cells,
wherein the plurality of digital switching blocks comprise 1×2^{N} digital switching blocks, with N being an integer value equal to a number of the plurality of LC cells or a number of the plurality of birefringent wedges for one of the plurality of digital switching blocks, and
wherein the input beams are subject to optical switching by the plurality of LC cells and the plurality of birefringent wedges of the plurality of digital switching blocks to produce output beams.

2. The optical switching apparatus of claim 1, wherein the optical switching apparatus comprises M input ports configured to receive the input beams from the plurality of optical fibers and N′ output ports configured to receive switched beams from the plurality of digital switching blocks, wherein M and N′ are integer values greater than or equal to 1.

3. The optical switching apparatus of claim 2, wherein the optical switching apparatus is configured to provide an M×N′ optical circuit switch with full switching functionality.

4. The optical switching apparatus of claim 2, wherein M and N′ are equal to 32, and the optical switching apparatus is configured to provide full switching functionalities for at least 32×32 ports of the optical switching apparatus.

5. The optical switching apparatus of claim 1, further comprising the plurality of optical fibers configured to deliver the input beams to the optical switching apparatus.

6. The optical switching apparatus of claim 5, further comprising at least one collimator array and, optionally, lenses, configured to align the input beams to the plurality of digital switching blocks.

7. The optical switching apparatus of claim 1, further comprising polarization diversity control optics configured to convert the input beams to input beams with linear polarization.

8. The optical switching apparatus of claim 7, wherein the polarization diversity control optics comprises a beam splitter configured to separate the input beams into multiple beams and at least one waveplate configured to rotate some of the multiple beams to provide the linear polarization.

9. The optical switching apparatus of claim 1, further comprising output polarization diversity optics for changing polarization of the output beams from linear polarization to an orthogonal linear state of polarization.

10. The optical switching apparatus of claim 9, wherein the output polarization diversity optics comprise at least one waveplate for rotating some of the output beams by 90 degrees so that the output beams are in the orthogonal linear state of polarization and at least one beam splitter for combining the output beams.

11. The optical switching apparatus of claim 9, further comprising at least one collimator array, and, optionally, lenses, for directing output beams from the plurality of switching blocks to a plurality of output fibers.

12. The optical switching apparatus of claim 1, further comprising output optical fibers configured to receive the output beams from the plurality of switching blocks of the optical switching apparatus.

13. The optical switching apparatus of claim 1, further comprising an optical alignment adjustment device configured to account for component tolerance in the input and/or output beam.

14. The optical switching apparatus of claim 13, wherein the optical alignment adjustment device comprises a TFT-LCD device.

15. The optical switching apparatus of claim 1, wherein the plurality of digital switching blocks are arranged as a one-dimensional or multidimensional input array configured to receive the input beams and a one-dimensional or multidimensional output array configured to receive the input beams from the input array and to provide output beams to a plurality of output optical fibers.

16. The optical switching apparatus of claim 15, wherein the input array and/or the output array comprise switching blocks of the plurality of digital switching blocks that are arranged in series in a single row of at least 16 blocks.

17. The optical switching apparatus of claim 16, wherein the input array and/or the output array comprise switching blocks of the plurality of digital switching block are arranged as a multi-dimensional array.

18. An optical switching assembly, comprising a plurality of input optical fibers;
a plurality of output optical fibers;
an input fiber array comprising a first plurality of digital switching blocks configured to receive input beams from the plurality of input optical fibers; and
an output fiber array comprising a second plurality of the digital switching blocks configured to produce output beams from switched beams received from the input fiber array, wherein digital switching blocks of the first and second pluralities of digital switching blocks comprise:
a plurality of liquid crystal (LC) cells configured to control polarization of an input beam arranged in series, and
a plurality of birefringent wedges that direct the input beam based on polarization, wherein one or more of the plurality of birefringent wedges is disposed between adjacent LC cells of the plurality of LC cells, and
wherein the digital switching blocks comprise 1×2^{N} digital switching blocks, with N being an integer value equal to a number of the plurality of LC cells or a number of the plurality of birefringent wedges for one of the digital switching blocks.

19. A computing device or data center comprising one or more of the optical switching assemblies of claim 18.

20. A Liquid Crystal on Silicon (LCoS) optical switch, comprising:
an input LCOS device configured to receive input beams from a plurality of input optical fibers and to selectively direct first-order diffracted beams to selected locations or pixels based on polarization; and
an output LCOS device configured to receive the first-order diffracted beams from the input LCOS device and to selectively direct the beams to a plurality of output optical fibers based on polarization of the diffracted beams.
